(19) United States
(12) Patent Application Publication
(10) Pub. No.: US 2026/0166904 A1
(43) Pub. Date: Jun. 18, 2026

(54) METHOD FOR PRINTING A SUBSTRATE WITH A SEALANT AND/OR ADHESIVE, AND ELECTROCHEMICAL CELL COMPRISING A PRINTED SEAL

(71) Applicant: Robert Bosch GmbH, Stuttgart (DE)

(72) Inventors: Fabiano Icisaca Indicatti, Sao Paulo (BR); Michael Raedler, Hamburg (DE)

(21) Appl. No.: 19/108,896

(22) PCT Filed: Sep. 4, 2023
(86) PCT No.: PCT/EP2023/074122

§ 371 Date: Mar. 5, 2025

(30) Foreign Application Priority Data
Sep. 5, 2022 (DE) 10 2022 209 196.5

(51) Int. Cl. B41M 1/12; B41F 15/08; B41M 1/26; B41M 3/00; H01M 4/02; H01M 4/04

(52) U.S. Cl. CPC B41M 1/12; B41F 15/0818; B41M 1/26; B41M 3/006; H01M 4/0414; H01M 2004/029

(57) ABSTRACT

The invention relates to a method for printing a substrate (1) with a sealant and/or adhesive (2) using a template (3) which has an upper face (3.1), a lower face (3.2), and at least one recess (4) which extends from the upper face (3.1) to the lower face (3.2), comprising the steps of
providing a substrate (1) which has a surface (1.1) to be printed comprising at least one local raised section (6),
placing the template (3) on the at least one local raised section (6) such that a gap (5) remains between the lower face (3.2) of the template (3) and the surface (1.1) to be printed,
applying the sealant and/or adhesive (2) onto the upper face (3.1) of the template (3),
filling the at least one recess (4) of the template (3) with the sealant and/or adhesive (2) using a doctor blade (7) which is drawn over the upper face (3.1) of the template (3) in a specified doctor blade direction (8), wherein air present in the recess (4) can be forced out of the recess (4) via the gap (5).

The invention additionally relates to an electrochemical cell comprising a printed seal (11).

### BACKGROUND

The invention relates to a method for printing a substrate with a sealant and/or adhesive. The substrate may in particular be a layer or coating of an electrochemical cell, for example a monopolar or bipolar plate, a separator plate, and/or a membrane electrode assembly. The printing of the substrate with the sealant and/or adhesive serves in particular to produce a seal. The invention additionally relates to an electrochemical cell comprising a printed seal.

Electrochemical cells, such as fuel cells, electrolysis cells, or battery cells, have a multilayer or multi-coating design. This design requires intermediate seals to separate the media supplied to one another during operation of a cell. To form the seals, a sealant and/or adhesive is applied to a layer or coating of the cell. Dispensing or printing methods are used in particular.

Mass production of electrochemical cells requires a high processing speed, i.e. short cycle times, as well as high process stability. Template printing in particular meets these requirements. In principle, the printing process for template printing is divided into the following three sub-processes:
1. applying the sealant and/or adhesive on the template previously placed on the substrate to be printed,
2. filling the template recess(es) with the sealant and/or adhesive in a doctor blade process,
3. triggering the sealant and/or adhesive from the template recess(es) by separating the template from the substrate.

The template thickness determines the layer height of the applied structure, wherein usual layer heights are in the range of 300 μm to 500 μm. However, for seals of electrochemical cells, layer heights of up to 1500 μm are required in order to achieve tolerance compensation and to be as free as possible in the design of the structures to be applied. This is because—depending on the respective sealing concept—the structures to be applied can be large and/or complex.

Accordingly, thicker templates must be used to achieve the layer heights required for seals of electrochemical cells in template printing. However, this increases the risk of air bubbles being incorporated during the doctor blade process for filling the template recess(es) with the applied sealant and/or adhesive, which subsequently lead to defects. This is because the volume of the template recess(es) to be filled with the sealant and/or adhesive also increases with the template thickness.

This problem is explained below with reference to FIGS. 1a) and 1b), which show a template 3 placed on a substrate 1 with a recess 4, which must be filled with a sealant and/or adhesive 2. To this end, a doctor blade 7 is drawn over the upper face 3.1 of the template 3. In the doctor blade direction 8 towards the end of the recess 4, not all the air can be forced out of the recess 4, so that an air bubble 13 forms in the recess 4, which prevents the recess 4 from being completely filled. In this case, the printed image is incomplete or has defects. The risk of an enclosed air bubble 13 increases with the thickness d of the template 3.

The present invention is concerned with the task of reducing the risk of air bubbles and thus defects when printing a substrate with a sealant and/or adhesive.

To solve the problem, the method according to the disclosure and the electrochemical cell according to the disclosure are proposed.

### SUMMARY

A method for printing a substrate with a sealant and/or adhesive using a template which has an upper face, a lower face and at least one recess which extends from the upper face to the lower face is proposed. The method comprises the steps of:
providing a substrate which has a surface to be printed comprising at least one local raised section,
placing the template on the at least one local raised section, such that a gap remains between the lower face of the template and the surface to be printed,
applying the sealant and/or adhesive onto the upper face of the template,
filling the at least one recess of the template with the sealant and/or adhesive using a doctor blade, which is drawn over the upper face of the template in a specified blade direction, wherein air present in the recess can be forced out of the recess via the gap.

The recess of the template can be vented via the gap during filling with the sealant and/or adhesive, so that the risk of air bubble formation is significantly reduced. Ventilation via the gap thus helps to avoid defects in the printed structure, which is particularly important when the method serves to produce a seal, for example a seal on a layer or coating of an electrochemical cell.

To fully vent the recess, it is not necessary for the gap between the lower face of the template and the surface to be printed to be circumferential and for the template to be raised over its entire surface in relation to the surface to be printed. The template can also rest on the surface to be printed in regions. In this case, the position of the gap is specified by the doctor blade direction, as ideally the gap in the doctor blade direction is behind the recess. That is to say, the recess in the area of the gap is the last to be filled with the sealant and/or adhesive. If the gap is circumferential, the doctor blade direction can be selected as required.

As the risk of air bubble formation is significantly reduced in the proposed method, the template thickness can be increased so that layer heights that are significantly above 300 μm, for example at 1500 μm as required for seals of electrochemical cells, can also be achieved. If the air gap is not circumferential, the layer height can vary slightly because the template is slightly inclined relative to the surface to be printed.

The at least one local raised section for forming the gap is preferably introduced or applied in a previous method step.

For example, prior to providing the substrate, the at least one local raised section is introduced into the substrate in a forming process, for example in an embossing process. If the substrate is a layer or coating of an electrochemical cell, in particular a monopolar, a bipolar or a separator plate made from a metal sheet, the at least one local raised section may be introduced during the manufacture of the plate.

Alternatively, prior to providing the substrate, the at least one local raised section is applied to the substrate by applying, in particular welding or gluing on, a platelet. The application of the platelet to form the at least one local raised section may then take place immediately prior to the actual printing process. The platelet need not be made of the same material as the template. Metal, in particular aluminum, or plastic is particularly suitable as a material. The shape of the platelet is largely arbitrary. For example, the platelet may have a square or round shape in plan view. Furthermore, more than one platelet may be applied to the surface of the substrate to be printed. Preferably, each applied platelet forms a separate local raised section. If a plurality of platelets is applied, they should preferably be arranged at a distance from each other.

The height of the at least one local raised section also defines the height of the gap in the area of that raised section. If the template rests in regions on the surface to be printed, the height of the gap varies. The maximum gap height is only achieved in the area of the at least one local raised section. Outside this range, the gap height continuously decreases down to the area in which the template rests on the surface to be printed.

Preferably, a gap is created between the lower face of the template and the surface to be printed, which has a height of 10-200 μm at least in the area of the local raised section, by applying the template to the at least one local raised section. That is to say, the at least one local raised section to be introduced or applied also has a height of 10-200 μm. Accordingly, the gap height is comparatively low, in particular compared to the height of the structure to be printed, if this structure is a seal of an electrochemical cell. The low gap height prevents the intrusion of sealant and/or adhesive, so that smears do not occur on the surface to be printed. The height of the gap is also sufficient to ensure the required ventilation of the recess during filling with the sealant and/or adhesive.

Furthermore, the template is brought into contact with the surface to be printed in regions upon placement on the at least one local raised section. In this case, the template is only raised in regions relative to the surface to be printed. The raised area is then to be positioned with respect to the doctor blade direction, such that the raised area or the gap in the doctor blade direction is at the end of the recess as far as possible.

Furthermore, it is proposed that, when the template is placed on the at least one local raised section, a distance between the at least one recess and the at least one local raised section is maintained. The distance ensures a safe venting of the recess, as air can flow more easily around the local raised section when the template is in place. The distance is preferably 1-10 mm.

If the at least one local raised section is formed by an applied platelet, it may be removed again upon printing of the substrate. The function of the printed substrate is thus not affected by the at least one local raised section. In some circumstances, the platelet may even be reused.

For example, the platelet may be glued on according to the type of label on the surface of the substrate to be printed. A labeling machine may then be used to apply the platelet.

The further proposed electrochemical cell comprises at least one layer or coating printed with a sealant and/or adhesive to form a seal. At a distance from the seal, at least one platelet is applied to, in particular, welded or glued on, to form a local raised section. The distance from the platelet to the seal is preferably 1-10 mm.

The previously described method according to the invention can in particular be used to produce the proposed electrochemical cell. In this case, a seal without defects is to be assumed, as the proposed method minimizes the risk of air bubble formation.

Preferably, the seal has a height H1 that is greater than a height H2 of the at least one platelet. When performing the method according to the invention described above, the height H1 of the printed seal is composed of the height H2 of the platelet and the thickness of the template. The height H2 of the platelet is preferably 10-200 μm. For example, the seal may have a height H1 of 1500 μm.

The layer or coating of the electrochemical cell printed with the sealant and/or adhesive is preferably a monopolar or bipolar plate, a separator plate, and/or a membrane-electrode assembly. As different media are fed between these layers, the printed seal can be used to achieve the necessary media separation.

### BRIEF DESCRIPTION OF THE DRAWINGS

Preferred embodiments of the invention are described in greater detail hereinafter with reference to the accompanying drawings. Shown are:

FIG. 1a) and b) a longitudinal section through a conventional device for printing a substrate during stripping using a doctor blade,

FIG. 2 a longitudinal section through a device according to the invention for printing a substrate with a sealant and/or adhesive,

FIG. 3 a plan view of a printed substrate, in particular a layer or coating of an electrochemical cell, with a printed seal,

FIG. 4 a longitudinal section through the substrate of FIG. 3,

FIG. 5 an enlarged section of FIG. 4 in the area of a local raised section of the substrate,

FIG. 6 an enlarged excerpt of FIG. 3 in the area of the local raised section,

FIG. 7 to 11 in each case a plan view of a printed substrate, in particular a layer or coating of an electrochemical cell, with a printed seal,

### DETAILED DESCRIPTION

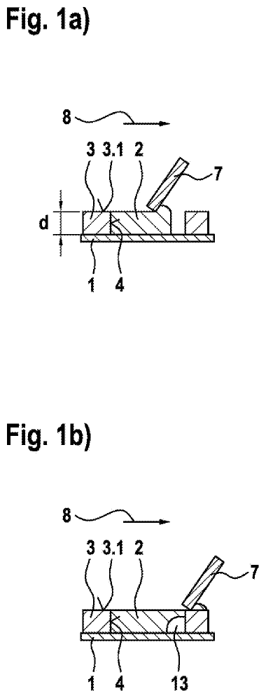

FIGS. 1a) and 1b) have already been used to describe the problem of air bubble formation during template printing in the description introduction, so that reference is made to the description introduction in relation to FIGS. 1a) and 1b).

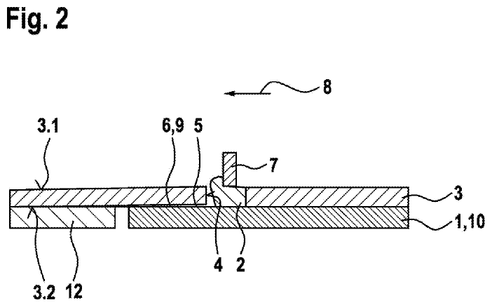

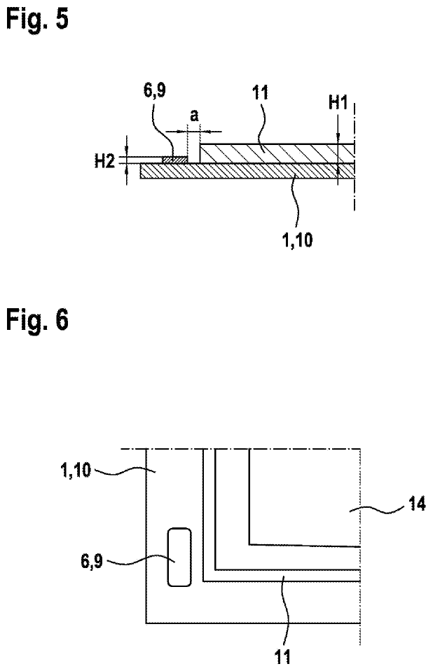

The invention and its advantages are described in more detail below with reference to FIGS. 2 to 11.

FIG. 2 shows a substrate 1, which is a layer or coating 10 of an electrochemical cell, for example a bipolar plate. The substrate 1 comprises a surface 1.1 to be printed, which is to be printed with a sealant and/or adhesive 2 to form a seal. In this respect, the method according to the invention is used.

In the method according to the invention, a platelet 9 is first applied to, for example glued on, the surface 1.1 of the substrate 1 to be printed, such that the platelet 9 forms a local raised section 6. Alternatively, the local raised section 6 can also already be formed into the substrate 1, such that the application of the platelet 9 is omitted. Subsequently, a template 3 with a recess 4 which extends from an upper face 3.1 to a lower face 3.2 of the template 3 is placed on the local raised section 6, such that the template 3 rests in regions on the local raised section 6 as well as in regions on the surface 1.1 to be printed. A gap 5 is thus formed between the lower face 3.2 of the template 3 and the surface 1.1 to be printed in the area of the local raised section 6. In FIG. 2, the gap 5 is arranged to the left of the recess 4 of the template 3. The position of the gap 5 with respect to the recess 4 provides a doctor blade direction 8. The doctor blade direction 8 is the direction in which a doctor blade 7 is drawn over the upper face 3.1 of the template 3 in order to fill the recess 4 with the sealant and/or adhesive 2 that has previously been applied to the upper face 3.1 of the template 3. In FIG. 2, the doctor blade direction 8 is indicated by an arrow. That is to say, the doctor blade 7 is drawn over the recess 4 towards the gap 5. The gap 5 thus allows a complete ventilation of the recess 4 so that it can be completely filled with the sealant and/or adhesive 2. The risk of air bubbles no longer exists due to the ventilation caused via the gap 5.

A compression force is applied to the template 3 via the doctor blades 7 when the sealant and/or adhesive 2 is removed, which can cause the template 3 to deform. Even with a deformation of the template 3, the local raised section 6 ensures the formation of the gap 5, such that the recess 4 can be ventilated via this. In order to support the template 3, a support element 12 can be provided, as exemplarily shown in FIG. 2, which forms an additional support for an area of the template 3 projecting beyond the substrate 1.

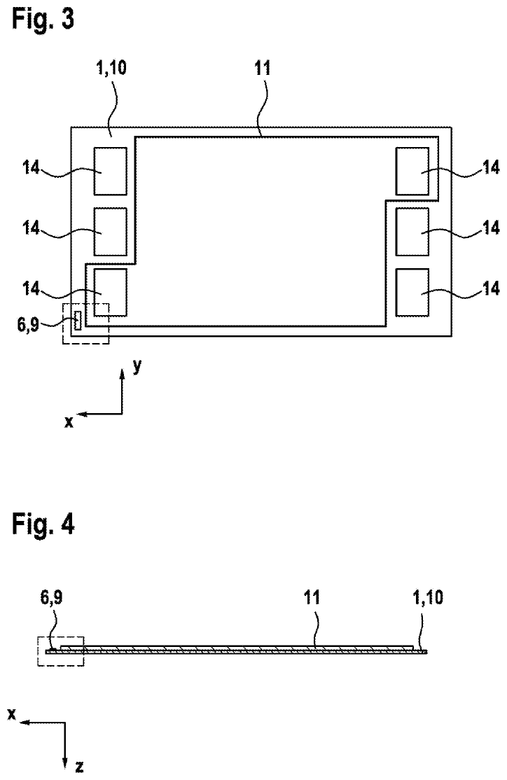

The exemplary embodiment shown in FIGS. 3 to 6 shows an already printed substrate 1. The substrate 1 is in turn a layer or coating 10 of an electrochemical cell, for example a bipolar plate. The substrate 1 has three openings at its two ends each forming ports 14 for media supply and media disposal. The required media separation is achieved with the aid of a seal 11, which has been printed on the substrate 1 according to the method according to the invention.

This can be seen on a platelet 9, which is arranged on the printed surface 1.1 of the substrate 1 to form a local raised section 6.

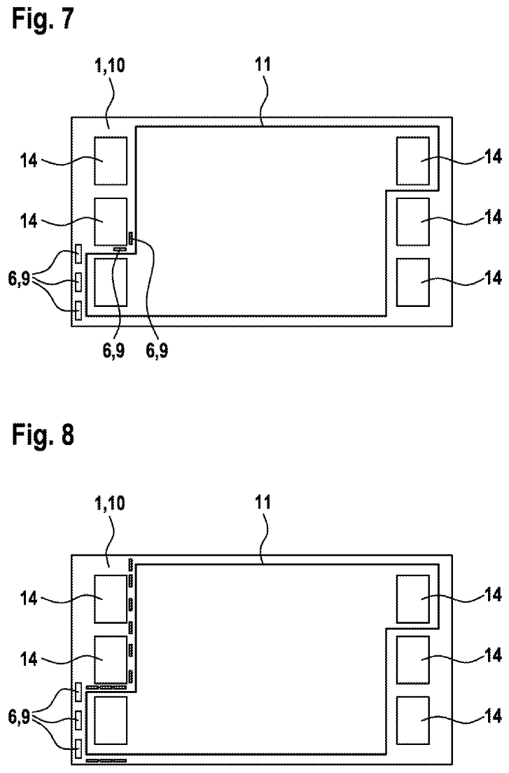

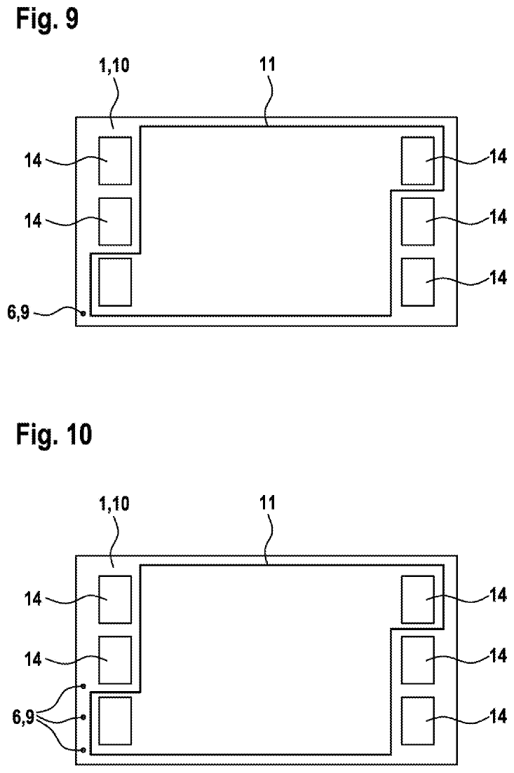

The fact that the method according to the invention was used here can be seen by the local raised section 6 in the form of an applied platelet 9. The platelet 9 is arranged at a distance a from the seal (see FIG. 5) in the area of an outer corner of the seal 11 (see FIG. 6). The distance a ensures that the desired ventilation through the platelet 9 is not affected. The positioning in the area of the outer corner allows ventilation in an area that is usually difficult to vent.

The platelet 9 has a height H2 that is significantly lower than the height H1 of the seal 11 to be achieved. As the height H2 of the platelet 9 adds to the height H1 of the seal 11 in the area of the local raised section 6, the height H1 of the seal 11 only varies slightly.

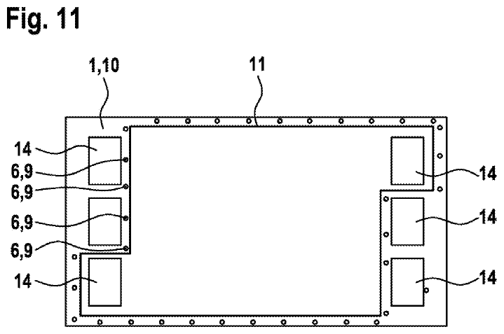

A plurality of platelets 9 can also be provided in place of the one platelet 9 arranged in the area of an outer corner of the seal 11. As exemplarily shown in FIG. 7, further platelets 9 can be arranged in the area of a further outer corner as well as an inner corner, which is usually also difficult to ventilate. The position of the platelet 9 to the left of the seal 11 shows that the doctor blade direction 8 has been taken into account in the positioning of the platelet 9. This does not exclude that further platelets 9 are provided for the formation of local raised sections 6 which extend across the corner (see FIG. 8).

In the exemplary embodiment of FIG. 9, only one platelet 9 is provided, namely in the area of an outer corner of the seal 11. In contrast to the embodiment of FIG. 3, the platelet 9 has a circular shape in the plan view.

Analogously to FIGS. 7 and 8, a plurality of platelets 9 with circular shape can also be provided (see FIG. 10).

Regardless of the shape, platelets 9 can also be arranged circumferentially around the seal 11 at regular intervals with respect to one another, such that when printing the substrate 1 to form the seal 11, the template 3 is lifted completely with respect to the surface 1.1 to be printed. In this case, the doctor blade direction 8 is irrelevant, as the gap 5 is also configured circumferentially.

1. A method for printing a substrate (1) with a sealant and/or adhesive (2) using a template (3) which has an upper face (3.1), a lower face (3.2) and at least one recess (4) which extends from the upper face (3.1) to the lower face (3.2), the method comprising:
providing a substrate (1) which has a surface (1.1) to be printed comprising at least one local raised section (6),
placing the template (3) on the at least one local raised section (6) such that a gap (5) remains between the lower face (3.2) of the template (3) and the surface (1.1) to be printed,
applying the sealant and/or adhesive (2) onto the upper face (3.1) of the template (3),
filling the at least one recess (4) of the template (3) with the sealant and/or adhesive (2) using a doctor blade (7) which is drawn over the upper face (3.1) of the template (3) in a specified doctor blade direction (8), wherein air present in the at least one recess (4) can be forced out of the at least one recess (4) via the gap (5).

2. The method according to claim 1,
wherein, prior to providing the substrate (1), the at least one local raised section (6) is introduced into the substrate (1) in a forming process, for

3. The method according to claim 1, wherein, prior to providing the substrate (1), the at least one local raised section (6) is applied to the substrate (1) by applying, a platelet (9).

4. The method according to claim 1, wherein the gap (5) is created between the lower face (3.2) of the template (3) and the surface (1.1) to be printed, which has a height (h) of 10-200 μm at least in an area of the local raised section (6), by applying the template (3) to the at least one local raised section.

5. The method according to claim 1,
wherein the template (3) is brought into contact with the surface (1.1) to be printed upon placement on the at least one local raised section (6).

6. The method according to claim 1,
wherein, when the template (3) is placed on the at least one local raised section (6), a distance (a) between the at least one recess (4) and the at least one local raised section (6) is maintained.

7. The method according to claim 1,
wherein the at least one local raised section (6) is removed after printing the substrate (1).

8. An electrochemical cell comprising at least one layer or coating (10) printed with a sealant and/or adhesive (2) to form a seal (11), wherein at least one platelet (9) for forming a local raised section (6) is applied to the seal.

9. The electrochemical cell of claim 8,
wherein the seal has a height (H1) that is greater than a height (H2) of the at least one platelet (9).

10. The electrochemical cell of claim 8,
wherein the layer or coating (10) is a monopolar or bipolar plate, a separator plate, and/or a membrane-electrode assembly.

11. The method according to claim 2, wherein, prior to providing the substrate (1), the at least one local raised section (6) is introduced into the substrate (1) by an embossing process.

12. The method according to claim 3, wherein, prior to providing the substrate (1), the at least one local raised section (6) is applied to the substrate (1) by welding or gluing the platelet (9) to the substrate (1).

13. The method according to claim 6, wherein the distance (a) is 1-10 mm.

14. The electrochemical cell according to claim 8, wherein the at least one platelet (9) for forming a local raised section (6) is welded or glued to the seal (11).

15. The electrochemical cell according to claim 8, wherein the at least one platelet (9) has a height of 1-10 mm.

16. The electrochemical cell according to claim 9, wherein the height (H2) is 10-200 μm.
